(19) United States
(12) Patent Application Publication
(10) Pub. No.: US 2025/0024391 A1
(43) Pub. Date: Jan. 16, 2025

(54) UPLINK TRANSMISSION METHOD, ELECTRONIC DEVICE AND COMPUTER READABLE STORAGE MEDIUM

(71) Applicant: Samsung Electronics Co., Ltd., Suwon-si, Gyeonggi-do (KR)

(72) Inventors: Min WU, Beijing (CN); Feifei SUN, Beijing (CN)

(21) Appl. No.: 18/709,602

(22) PCT Filed: Nov. 15, 2022
(86) PCT No.: PCT/KR2022/017959

§ 371 Date: May 13, 2024

(30) Foreign Application Priority Data
Nov. 15, 2021 (CN) 202111350276.9

(51) Int. Cl. H04W 56/00; H04W 72/0453; H04W 74/0833

(52) U.S. Cl. CPC H04W 56/0035; H04W 72/0453; H04W 74/0833

(57) ABSTRACT

The disclosure relates to a 5G or 6G communication system for supporting a higher data transmission rate. Embodiments herein provide a method performed by a User Equipment (UE), and the method comprises receiving pre-compensated frequency offset configured by a base station and performing an uplink transmission based on the pre-compensated frequency offset.

### TECHNICAL FIELD

The disclosure relates to the field of wireless communication technologies, and in particular, relates to an uplink transmission method, an electronic device and a computer readable storage medium.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

An object of the embodiments of the present application is to solve the problem that how to perform uplink frequency synchronization without the assistance of GNSS.

An aspect of the disclosure provides a method performed by a User Equipment (UE), and the method comprises receiving pre-compensated frequency offset configured by a base station and performing an uplink transmission based on the pre-compensated frequency offset.

### BRIEF DESCRIPTION OF DRAWINGS

The above and other aspects, features, and advantages of certain embodiments of the disclosure will be more apparent from the following detailed description taken in conjunction with the accompanying drawings, in which:

FIG. 1 is a schematic diagram of the overall structure of a wireless network according to an embodiment of the present application;

FIG. 2A is a schematic diagram of transmission path according to an embodiment of the present application;

FIG. 2B is a schematic diagram of reception path according to an embodiment of the present application;

FIG. 3A is a structural schematic diagram of a UE according to an embodiment of the present application;

FIG. 3B is a structural schematic diagram of a base station according to an embodiment of the present application;

FIG. 4 is a schematic diagram of a flow of a method performed by a UE according to an embodiment of the present application;

FIG. 5 is an exemplary diagram of a RAR including a pre-compensated frequency offset control indication field according to an embodiment of the present application;

FIG. 6 is an exemplary diagram of another RAR including a pre-compensated frequency offset control indication field according to an embodiment of the present application;

FIG. 7 is an exemplary diagram of a DCI format in which a set of amount of adjustments for frequency offset and TA is indicated for a UE according to an embodiment of the present application;

FIG. 8 is a schematic diagram of a flow of another method performed by a UE according to an embodiment of the present application;

FIG. 9 is a schematic diagram of different common frequency offsets according to an embodiment of the present application;

FIG. 10 is a schematic diagram of a flow of a method performed by a base station according to an embodiment of the present application;

FIG. 11 is a schematic diagram of a flow of another method performed by a base station according to an embodiment of the present application;

FIG. 12 is a structural schematic diagram of an electronic device according to an embodiment of the present application;

FIG. 13 illustrates a structure of a UE according to an embodiment; and

FIG. 14 illustrates a structure of a base station according to an embodiment.

### BEST MODE FOR CARRYING OUT THE INVENTION

The following description with reference to the accompanying drawings is provided to assist in a comprehensive understanding of various embodiments of the present application as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present application. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present application. Accordingly, it should be apparent to those skilled in the art that the following description of various embodiments of the present application is provided for illustration purpose only and not for the purpose of limiting the present application as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present application and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present application includes any or all of combinations of listed words. For example, the expression “A or B” may include A, may include B, or may include both A and B.

Unless defined differently, all terms used herein, which include technical terminologies or scientific terminologies, have the same meaning as understood by person skilled in the art. Such terms as those defined in a generally used dictionary are to be interpreted to have the meanings equal to the contextual meanings in the relevant field of art, and are not to be interpreted to have ideal or excessively formal meanings unless clearly defined in the present application.

The exemplary embodiments of the present application are further described below in conjunction with the accompanying drawings.

The text and drawings are provided as examples only to help readers understand the present application. The text and drawings are not intended and should not be interpreted as limiting the scope of the present application in any way. Although certain embodiments and examples have been provided, based on the content disclosed herein, it is obvious to those skilled in the art that modifications to the illustrated embodiments and examples can be made without departing from the scope of the present application.

The various embodiments discussed below for describing the principles of the present disclosure are for illustration only and should not be interpreted as limiting the scope of the present disclosure in any way. Those skilled in the art will understand that the principles of the present disclosure can be implemented in any suitably arranged wireless communication system. For example, although the following detailed description of the embodiments of the present disclosure will be directed to LTE and 5G communication system, those skilled in the art can understand that the main points of the present disclosure can also be applied to other communication systems with similar technical backgrounds and channel formats with slight modifications without departing from the scope of the present disclosure. For example, the communication systems may include a global system for mobile communications (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD), UMTS, worldwide interoperability for microwave access (WiMAX) communication system, a 5G system or new radio (NR), etc. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE (Long Term Evolution) systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In 5G Rel-16 standard of 3GPP, research on Non-terrestrial networks (NTN) is being conducted. In Rel-17 standard, the first version of the new radio (NR) NTN standard was developed. With the wide area coverage capability of satellites, NTN enables operators to provide commercial 5G services in areas with underdeveloped terrestrial network infrastructure, enabling guaranteed continuity of 5G services, especially plays its roles in scenarios such as emergency communications, maritime communications, aviation communications and communications along railways.

In Rel-17 standard of NR NTN, an NTN terminal is assumed to have a global navigation satellite system (GNSS), the terminal can obtain its own location information based on the GNSS, and estimate the transmission latency and frequency offset of the serving link between the terminal and the satellite in conjunction with the location information of the satellite broadcasted by the base station, and uses the estimated latency and frequency offset for pre-compensation of an uplink transmission. In practice, however, some terminals may not have GNSS capability, or, in some special cases, the GNSS function does not work properly, so how to achieve uplink time-frequency synchronization without the assistance of GNSS is a problem.

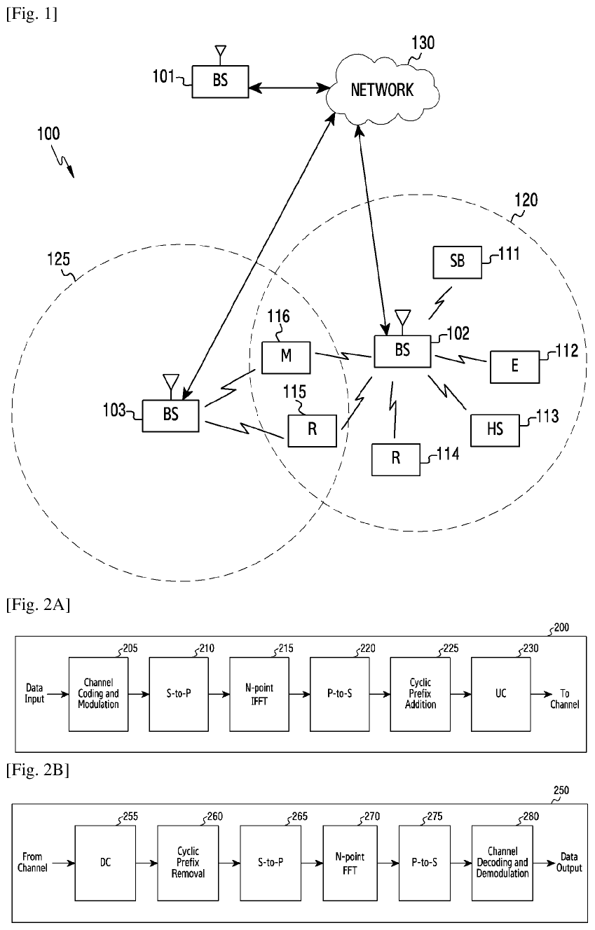

FIG. 1 illustrates an example wireless network 100 according to various embodiments of the present application. The embodiment of the wireless network 100 shown in FIG. 1 is for illustration only. Other embodiments of the wireless network 100 can be used without departing from the scope of the present application.

The wireless network 100 includes a gNodeB (gNB) 101, a gNB 102, and a gNB 103. GNB 101 communicates with gNB 102 and gNB 103. GNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

GNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present application. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

FIGS. 2A and 2B illustrate example wireless transmission and reception paths according to the present application. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present application.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present application. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

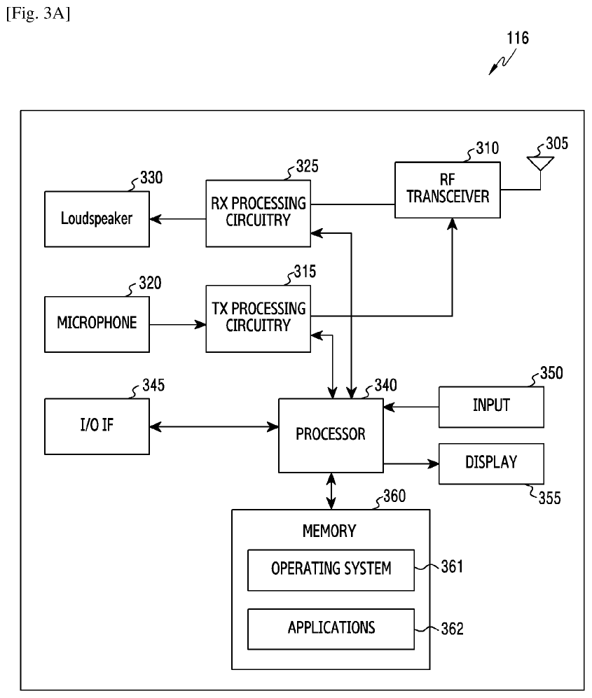

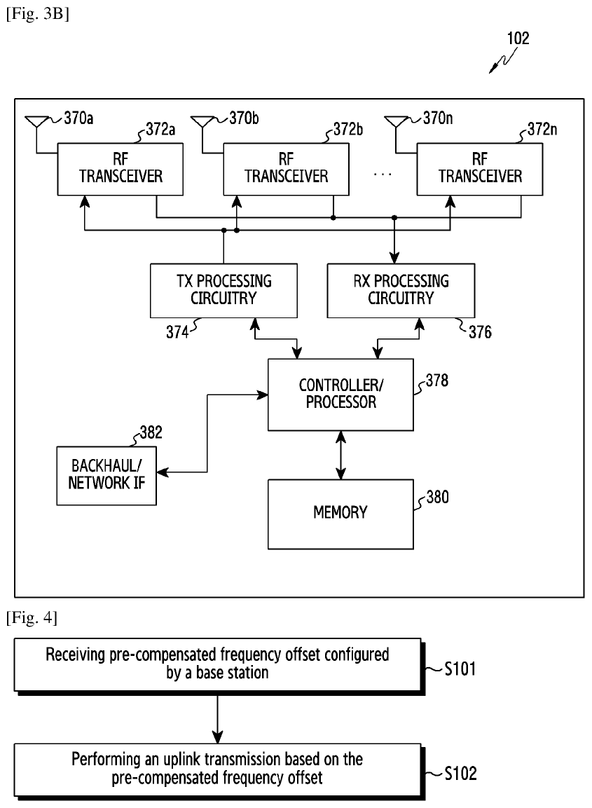

FIG. 3A illustrates an example UE 116 according to the present application. The embodiment of UE 116 shown in FIG. 3A is for illustration only, and UEs 111-115 of FIG. 1 can have the same or similar configuration. However, a UE has various configurations, and FIG. 3A does not limit the scope of the present application to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present application. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present application. The embodiment of gNB 102 shown in FIG. 3B is for illustration only, and other gNBs of FIG. 1 can have the same or similar configuration. However, a gNB has various configurations, and FIG. 3B does not limit the scope of the present application to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present application. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In NTN, depending on whether a satellite has the capability to perform decoding on 5G signals, scenarios can be classified into two types: scenarios based on transparent payload and scenarios based on regenerative payload. In scenarios based on transparent payload, the satellites do not have the capability to perform decoding on 5G signals, and receive the 5G signals transmitted by ground terminals and pass through the received 5G signals directly to NTN gateways on the ground. That is, the satellites play a role of forwarding radio signals between ground terminals and NTN gateways on the ground. In scenarios based on regenerative payload, the satellites have the capability to perform decoding on 5G signals, and receive the 5G signals transmitted by ground terminals and perform decoding on the received 5G signals and then re-encode the decoded data and send it out. The re-encoded data can be transmitted directly to NTN gateways on the ground. Alternatively, the re-encoded data can be transmitted to other satellites, and then relayed by the other satellites to NTN gateways on the ground. That is, the satellites play a role of performing decoding and forwarding on radio signals between ground terminals and NTN gateways on the ground.

In an embodiment of the present application, a link between a ground terminal and a satellite is referred to as Service Link, and a link between a satellite and an NTN gateway on the ground is referred to as Feeder Link. That is, each of these two links is included in uplink transmission and downlink transmission. Whether it is Service Link or Feeder Link, there is a problem of time and frequency synchronization. Due to the extremely high altitude of satellites from the ground (for example, the altitude of a low-orbiting satellite is 600 km or 1,200 km, and the altitude of a synchronous satellite is 36,000 km), both of the communication distance between a ground terminal and a satellite and the communication distance between an NTN gateway on the ground and a satellite are extremely large, thus the time synchronization and the frequency synchronization of the Service Link and Feeder Link are greatly influenced. Especially for some terminals without GNSS capability or cases in which the GNSS capability cannot be used normally under special circumstances, how to achieve uplink time-frequency synchronization is a problem.

The uplink transmission method, the electronic device and the computer readable storage medium according to an embodiment of the present application are intended to provide relevant details on uplink frequency synchronization.

There is provided a method performed by a UE according to an embodiment of the present application, as shown in FIG. 4, the method includes:

Step S101: Receiving pre-compensated frequency offset configured by a base station;

Step S102: Performing an uplink transmission based on the pre-compensated frequency offset.

In an embodiment of the present application, considering that the frequency offset of the signal transmissions between different ground terminals (UEs) and the same satellite may be different, and the value of a frequency offset depends on the relative speed of movement between the ground terminal and the satellite are taken into account. In fact, for non-synchronous satellites moving at high speed relative to the ground, the relative speed of movement between the ground terminal and the satellite depends mainly on the speed of movement of the satellite relative to the ground, and is less relevant with the speed of movement of the terminal relative to the ground. Therefore, it can be assumed that the ground terminal is stationary relative to the ground and the base station can roughly estimate the frequency offset of the signal transmission between the ground terminal and the satellite based on the movement speed of the satellite and broadcast this frequency offset to the cell terminal for pre-compensation of the uplink transmission on the terminal (UE) side.

The UE receives the pre-compensated frequency offset configured by the base station and performs uplink transmission based on this pre-compensated frequency offset.

In an embodiment of the present application, the base station can estimate the remaining frequency offset amount based on the received uplink transmissions which have been pre-compensated for the frequency offset by the terminal, and perform post-compensation on the received uplink transmissions for frequency offset, thereby performing decoding on uplink transmissions. This method can be called open-loop uplink frequency offset control. Alternatively, the base station further informs the terminal of the estimated remaining frequency offset, i.e., the terminal can perform pre-compensation on uplink transmissions for whole frequency offset, and this method can be called closed-loop uplink frequency offset control.

In an embodiment of the present application, the pre-compensated frequency offset configured by the base station includes at least one of the following:
common pre-compensated frequency offset configured by the base station through the system information; and
UE specific pre-compensated frequency offset configured by the base station through UE specific signaling.

Where for convenience of the description, hereinafter, the common pre-compensated frequency offset can also be referred to simply as common frequency offset (information), and the UE specific pre-compensated frequency offset can also be referred to simply as UE specific frequency offset (information).

Further, the UE specific pre-compensated frequency offset configured by the base station through the UE specific signaling includes at least one of the following:
UE specific pre-compensated frequency offset configured by the base station through the RAR; and
UE specific pre-compensated frequency offset configured by the base station through at least one of RRC signaling, MAC CE and DCI.

In one possible embodiment of the present application, the UE receives the common pre-compensated frequency offset configured by the base station through the system information, and uses it for PRACH for initial random access; and UE receives in RAR the UE specific pre-compensated frequency offset configured by the base station, and use it for subsequent uplink transmission. The common frequency offset and the UE specific frequency offset can also be construed as uplink pre-compensated frequency offset in the initial random access procedure.

In another possible embodiment of the present application, the base station indicates the common frequency offset through the system information, but does not support the UE specific frequency offset configured through the RAR. After the UE enters a RRC connected status, the base station may configure the UE specific frequency offset through at least one of RRC signaling, MAC CE and DCI, thereby avoiding modification to RAR specification.

In yet another possible embodiment of the present application, the base station indicates the common frequency offset only through the system information without the need of configuring the UE specific frequency offset, so as to save signaling overhead. The UE performs pre-compensation on the uplink transmissions before and after the establishment of RRC connected status based on the common frequency offset, and the residual frequency offset may be solved by the base station by means of post-compensation.

In still another possible embodiment of the present application, the base station does not need to configure the common frequency offset for UEs without GNSS capability, and detection with greater frequency offset range can be supported by the system via enhancement of PRACH format. A UE without GNSS capability initiates an initial random access procedure by using enhanced PRACH format. That is, there is no need to perform frequency offset pre-compensation for PRACH. The UE specific frequency offset is configured by the base station through the RAR. Or, after the entry of the RRC connected status, the UE specific frequency offset is configured by the base station through at least one of RRC signaling, MAC CE and DCI. The UE performs pre-compensation on uplink transmission based on the UE specific frequency offset after receiving the UE specific frequency offset.

In an embodiment of the present application, if the pre-compensated frequency offset includes the common pre-compensated frequency offset and the UE specific pre-compensated frequency offset, Step S102 may specifically include:
performing the uplink transmission based on a sum of the common pre-compensated frequency offset and the UE specific pre-compensated frequency offset.

Alternatively, after the UE specific pre-compensated frequency offset is received, the uplink transmission is performed based only on the UE specific pre-compensated frequency offset (instead of the common pre-compensated frequency offset).

In particular, the UE specific pre-compensated frequency offset includes at least one of the following:
absolute amount for a UE specific pre-compensated frequency offset, that is, the frequency offset indicated by the base station may be an absolute amount. The absolute amount can be used for replacing the UE specific pre-compensated frequency offset used by the UE last time; and
relative adjustment amount for UE specific pre-compensated frequency offset, that is, the frequency offset indicated by the base station may be a relative amount of adjustment. The relative adjustment amount is an amount of adjustment relative to the UE specific pre-compensated frequency offset used by the UE last time (i.e., an amount of adjustment relative to the pre-compensated frequency offset used in the previous uplink transmission). The adjusted frequency offset can be used for the pre-compensation of the uplink transmission. Specifically, UE can adjust the frequency offset according to the following formula:

$${DedicatedFO}_{new} = {DedicatedFO}_{old} + AdjustmentOfDedicatedFO$$

wherein DedicatedFO_{new} is the adjusted UE specific frequency offset, DedicatedFO_{old} is the last UE specific frequency offset used by the UE for an uplink transmission, and AdjustmentOfDedicatedFO is the amount of adjustment indicated by the base station through MAC CE, and/or DCI. Further, the adjustment range of the AdjustmentOfDedicatedFO can be additionally configured by RRC signaling. Since the amount of adjustment for frequency offset needs to be indicated by the base station, this method can also be called closed-loop uplink pre-compensated frequency offset control.

In an embodiment of the present application, the system can simultaneously support two types of signaling for UE specific frequency offset: one is an absolute frequency offset; and the other one is a relative frequency offset, i.e., the amount of adjustment relative to the frequency offset used by the UE last time. That is, signaling for indicating the absolute frequency offset may require more bits to indicate a larger frequency offset range. The advantage of supporting both types of signaling is that sufficient flexibility may be provided to the system and signaling overhead is saved as much as possible. For example, when the varying amount of a frequency offset is within the range indicated by the relative frequency offset, the base station configures the relative frequency offset for the UE; and if the varying amount of frequency offset exceeds the range indicated by the relative frequency offset, the base station configures the absolute frequency offset for the UE to maintain the uplink frequency synchronization for the UE.

In one possible embodiment of the present application as described above, the base station indicates the common frequency offset through the system information, and indicates the UE specific frequency offset through the RAR. After the UE specific frequency offset indicated through the RAR is received, pre-compensation is performed on uplink transmission based on the sum of the UE specific frequency offset and the common frequency offset, or pre-compensation is performed on uplink transmission based on the UE specific frequency offset.

In one possible embodiment of the present application as described above, the base station indicates the common frequency offset through the system information, and configures the UE specific frequency offset through at least one of RRC signaling, MAC CE and DCI after the UE enters a RRC connected status. After receiving the UE specific frequency offset, the UE performs pre-compensation on uplink transmission based on the sum of the UE specific frequency offset and the common frequency offset, or the UE performs pre-compensation on uplink transmission based only on the UE specific frequency offset.

In conjunction with one or more embodiments above, the base station indicates the common frequency offset through the system information, and indicates the UE specific frequency offset through the RAR. The specific process may include at least of one of the following steps:

First step: receiving the system information, and obtaining the common frequency offset information for an uplink transmission configured by the base station from the system information.

Second step: using the received common frequency offset for pre-compensation of PRACH and initiating a random access procedure. That is, the UE performs pre-compensation on Message (Msg)1 (i.e., PRACH) based on the common frequency offset in a four-step random access procedure; and/or the UE performs pre-compensation on MsgA including PRACH and Physical Uplink Shared Channel (PUSCH) based on the common frequency offset in a two-step random access procedure. In other words, for the two-step random access procedure, the UE needs to perform pre-compensation on both PUSCH and PRACH included in MsgA.

Third step: receiving a random access response, and obtaining the UE specific frequency offset information for an uplink transmission configured by the base station from the random access response.

Fourth step: using the received UE specific frequency offset instead of the common frequency offset for an uplink transmission after the random access response, or using the sum of the UE specific frequency offset and the common frequency offset for an uplink transmission after the random access response. For example, during the four-step random access procedure, the UE specific frequency offset or the sum of the UE specific frequency offset and the common frequency offset is used for Msg3.

In the above mentioned fourth step, the UE may calculate the pre-compensated frequency offset for the uplink transmission (mainly referring to Msg3 or MsgB) after PRACH by the formula as follows:

$$FO = {FO}_{UE \_ specific} + {FO}_{Common}$$

where, FO_{Common} is the common frequency offset for uplink indicated through the system information, and FO_{UE_specific} is the UE specific frequency offset for uplink indicated through the random access response. FO_{UE_specific} may be a positive number, i.e., positive adjustment with respect the common frequency offset, or, FO_{UE_specific} may be a positive number or a negative number, i.e., positive adjustment or negative adjustment with respect the common frequency offset.

In an embodiment of the present application, the physical meaning of the common frequency offset indicated through the system information may be frequency offset corresponding to the Feeder Link between a satellite and an NTN gateway on the ground, or the common frequency offset corresponds to the frequency offset of the Service Link between one reference point position on the ground of a cell and a satellite, or the common frequency offset corresponds to the sum of frequency offsets of the Feeder Link and Service Link. In a real system, the physical meaning of the common frequency offset may depend on configurations of the base station.

In an embodiment of the present application, the base station configures a common frequency offset through the system information, and the common frequency offset is also referred to as Cell Specific frequency offset and used for all terminals within the cell.

In an embodiment of the present application, the common pre-compensated frequency offset configured by the base station through the system information includes more than one common pre-compensated frequency offset configured by the base station through the system information, the more than one common pre-compensated frequency offset correspond to different SSB indexes respectively. That is, the base station configures a plurality of common frequency offsets through the system information, and the plurality of common frequency offsets correspond to uplink transmissions in different beam directions respectively. That is, each of the common frequency offsets is associated with one SSB index. In other words, each of the common frequency offsets is associated with one PRACH resource (the PRACH resource is associated with one SSB index). The common frequency offset can also be referred to as beam specific frequency offset, and each of the common frequency offsets can be used for the uplink transmission corresponding to its associated beam, e.g., each of the common frequency offsets can be used for the PRACH corresponding to its associated beam.

In an embodiment of the present application, the common frequency offset configured by the base station through the system information is applicable to terminals with GNSS capability and terminals without GNSS capability in a cell, that is, the same one common frequency offset is used by the two types of terminals.

In an embodiment of the present application, the common pre-compensated frequency offset configured by the base station through the system information includes two common pre-compensated frequency offsets configured by the base station through the system information, the two common pre-compensated frequency offsets correspond to UEs with GNSS capability and UEs without GNSS capability respectively. That is, the base station configures common frequency offsets respectively for UEs with GNSS capability and UEs without GNSS capability in the system information, i.e., the two types of terminals have different common frequency offsets.

In an embodiment of the present application, the common frequency offset configured by the base station in system information is only applicable to terminals without GNSS capability in a cell, and for terminals with GNSS capability in a cell, the pre-compensated frequency offset for an uplink transmission can be estimated based on their own position information, position information of the satellite and/or the speed of motion of the satellite relative to the ground.

In an embodiment of the present application, the UE specific pre-compensated frequency offset and the common pre-compensated frequency offset are in units of normalized reference subcarrier spacing; the indication value for the frequency offset is represented by the normalized subcarrier spacing. For example, the frequency offset is an integer or fractional multiples of the reference subcarrier spacing; i.e., the UE specific pre-compensated frequency offset and the common pre-compensated frequency offset is an integer or fractional multiples of the reference subcarrier spacing.

By way of an example, the whole frequency offset for an uplink transmission includes a common frequency offset and a UE specific frequency offset, and each of the two types of the frequency offsets is in units of subcarrier spacing.

In an embodiment of the present application, the reference subcarrier spacing includes at least one of the following:
a subcarrier spacing of an initial uplink BWP configured by the base station through the system information, e.g., the subcarrier spacing for normalizing the common frequency offset can be a subcarrier spacing used by an initial uplink bandwidth part configured by a cell;
a subcarrier spacing of uplink activated BWP for the UE, e.g., the subcarrier spacing for normalizing the UE specific frequency offset can be a subcarrier spacing used by the uplink activated BWP for the UE;
a subcarrier spacing configured by the base station, i.e., the subcarrier spacing for normalizing the frequency offset can be configured by the base station; and
a predefined subcarrier spacing, i.e., the subcarrier spacing for normalizing the frequency offset can be predefined.

In an embodiment of the present application, the common frequency offset configured through the system information and the UE specific frequency offset configured through at least one of RRC signaling, MAC CE and DCI may have different indication granularities. If the UE specific frequency offset is used to indicate the residual frequency offset, the range indicated by the UE specific frequency offset may be much smaller than the common frequency offset. That is, the former has thinner indication granularity than the latter, and the number of bits of information required for the former will also be less than the number of bits of information required for the latter.

In an embodiment of the present application, the method further includes: receiving drift rate of the common pre-compensated frequency offset configured by the base station through the system information; wherein the drift rate of the common pre-compensated frequency offset is used to update the common pre-compensated frequency offset.

Due to the very fast movement of the satellite, the Doppler frequency offset may change dynamically over time and the base station needs to continuously update the common frequency offset, the update period of the common frequency offset indicated by the system information cannot exceed the minimum system information modification period specified in the standard. In addition, whenever the common frequency offset is updated, it means that the system information is changed and the base station needs to transmit a paging message to wake up all the camping UEs within a cell to receive the updated system information, which adds additional power consumption for UEs that do not need to acquire the common frequency offset. Based on this, in order to reduce the frequency of common frequency offset updates in the system information, in addition to indicating the common frequency offset in the system information, the drift rate of the common frequency offset, i.e., the amount of frequency offset that drifts per unit of time, is also indicated. The terminal can update the common frequency offset based on the drift rate indicated by the base station and then use the updated common frequency offset for an uplink transmission by using the following formula:

$${CommonFO}_{update} = {CommonFO}_{indicated} + ( {T}_{update} - {T}_{reference} ) * DriftRateOfCommonFO$$

wherein CommonFO_{update} is the common frequency offset updated by the UE, CommonFO_{indicated} is the common frequency offset indicated in the system information, T_{update} is the time point at which the UE updates the common frequency offset, T_{reference} is a reference time point at which the common frequency offset comes into effect, and DriftRateOfCommonFO is the drift rate of the common frequency offset indicated in the system information.

In an embodiment of the present application, the method further includes: determining the reference time point at which the common pre-compensated frequency offset comes into effect; wherein the reference time point is used to update the common pre-compensated frequency offset.

Specifically, the reference time point includes at least one of the following:
a reference time point indicated by the base station, i.e., T_{reference} can be indicated by the base station directly, for example, the base station can indicate T_{reference} and the common pre-compensated frequency offset in the same system information;
T_{reference} may be by default starting point or ending point of a system information modification period in which a system information transmission carries the common pre-compensated frequency offset;
T_{reference} may be by default starting point or ending point of a system information window in which the system information transmission carries the common pre-compensated frequency offset;
T_{reference} may be by default starting point or ending point of a slot, a subframe, and a radio frame in which a system information carrying the common pre-compensated frequency is firstly transmitted in a system information window;
T_{reference} may be by default starting point or ending point of a most recent radio frame with SFN=0 or hybrid-SFN=0 before the system information transmission carrying the common pre-compensated frequency offset;
T_{reference} may be by default starting point or ending point of a subframe, a slot, and a radio frame in which the system information transmission carrying the common pre-compensated frequency offset is received by the UE;
T_{reference} may be by default starting point or ending point of a subframe, a slot, and a radio frame in which a first repetition transmission for the system information transmission carrying the common pre-compensated frequency offset is received by the UE;
T_{reference} may be by default starting point or ending point of the system information transmission carrying the common pre-compensated frequency offset received by the UE; and

T_{reference} reference may be by default starting point or ending point of a first slot, subframe, or radio frame after the corresponding system information transmission carrying the common pre-compensated frequency offset is received by the UE.

In an embodiment of the present application, the method further includes: receiving a validity period of the common pre-compensated frequency offset configured by the base station through the system information; wherein the validity period of the common pre-compensated frequency offset is used to restrict lifetime of the common pre-compensated frequency offset.

That is, in addition to indicating the common frequency offset in the system information, the base station indicates the validity period of the common frequency offset additionally. Alternatively, the validity period of the common frequency offset is a predefined value. The UE considers all the common frequency offsets received within the validity period to be valid, and the UE considers the common frequency offsets received outside the validity period to be invalid. If the UE needs to transmit a PRACH for access to a network, then the UE needs to re-receive the system information to obtain the latest common frequency offset.

The UE can perform management on whether the common pre-compensated frequency offset is valid by using a timer. For example, the UE can start a timer with pre-configured time duration at the starting time of the validity period of the common pre-compensated frequency offset. When the timer runs, the common pre-compensated frequency offset is considered to be valid, and when the timer expires, the common pre-compensated frequency offset is considered to be invalid.

In an embodiment of the present application, the starting time of the validity period of the common pre-compensated frequency offset includes at least one of the following:
a time point indicated by the base station, e.g., the starting time of the validity period of the common pre-compensated frequency offset indicated by the base station through RRC signaling; for another example, the base station can indicate common pre-compensated frequency offset, validity period of the common pre-compensated frequency offset, and the starting time of the validity period in the same system information;
the starting time of the validity period of the common pre-compensated frequency offset may be by default starting point or ending point of a system information modification period in which a system information transmission carries the common pre-compensated frequency offset;
the starting time of the validity period of the common pre-compensated frequency offset may be by default starting point or ending point of a system information window in which the system information transmission carries the common pre-compensated frequency offset;
the starting time of the validity period of the common pre-compensated frequency offset may be by default starting point or ending point of a slot, a subframe, and a radio frame in which a system information carrying the common pre-compensated frequency is firstly transmitted in a system information window;
the starting time of the validity period of the common pre-compensated frequency offset may be by default starting point or ending point of a most recent radio frame with SFN=0 or hybrid-SFN=0 before the system information transmission carrying the common pre-compensated frequency offset;
the starting time of the validity period of the common pre-compensated frequency offset may be by default starting point or ending point of a subframe, a slot, and a radio frame in which the system information transmission carrying the common pre-compensated frequency offset is received by the UE;
the starting time of the validity period of the common pre-compensated frequency offset may be by default starting point or ending point of a subframe, a slot, and a radio frame in which a first repetition transmission for the system information transmission carrying the common pre-compensated frequency offset is received by the UE;
the starting time of the validity period of the common pre-compensated frequency offset may be by default starting point or ending point of the system information transmission carrying the common pre-compensated frequency offset is received by the UE; and
the starting time of the validity period of the common pre-compensated frequency offset may be by default starting point or ending point of a first slot, subframe, or radio frame after the corresponding system information transmission carrying the common pre-compensated frequency offset is received by the UE.

In an embodiment of the present application, instead of indicating the validity period of the common frequency offset directly, the base station may indicate the time point at which the common frequency offset becomes invalid. The invalid time point can be indicated as an absolute time point. Alternatively, the invalid time point can be indicated as a relative time point, i.e., indicated as an offset amount relative to a predefined reference time point. After the invalid time point of the common frequency offset, the UE needs to re-receive the system information to obtain the latest common frequency offset.

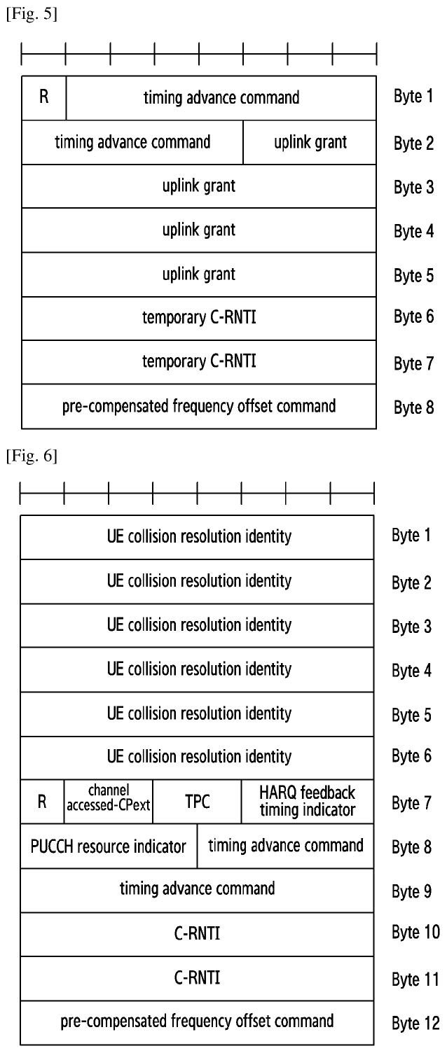

In an embodiment of the present application, the RAR includes an indication field for indicating whether the UE specific pre-compensated frequency offset is included in the RAR. Specifically, the RAR may include a field for indicating the uplink pre-compensated frequency offset, e.g., a field for indicating the uplink pre-compensated frequency offset control, which is one byte (8 bits) added based on the existing RAR format. As shown in FIG. 5, the RAR may be used as a RAR for a four-step random access procedure or a fallback RAR for a two-step random access procedure; and in FIG. 6, the RAR may be used as a success RAR for a two-step random access procedure. This enhanced RAR format may be multiplexed with the existing RAR format within a MAC PDU. For example, the enhanced RAR format is used for UEs without GNSS capability, and the existing RAR format is used for UEs with GNSS capability. The two types of UEs may be included in a cell at the same time. In order to distinguish between the enhanced RAR format (including a frequency offset indication field) and the existing RAR format (not including a frequency offset indication field), the reserved bit “R” in the RAR can be used to distinguish between the two RAR formats. For example, if the “R” field indication bit is 0, it corresponds to the RAR format not including a frequency offset indication field; and if the “R” field indication bit is 1, it corresponds to the RAR format including a frequency offset indication field.

In conjunction with one or more embodiments above, after the UE enters a RRC connected status, the base station configures uplink pre-compensated frequency offset for UEs through at least one of RRC signaling, MAC CE and DCI. Where the common frequency offset is configured through the system information, the uplink pre-compensated frequency offset configured for UEs through at least one of RRC signaling, MAC CE and DCI can also be referred to as UE specific frequency offset to be distinguished from the common frequency offset.

The specific process may include at least of one of the following steps:

First step: receiving UE specific frequency offset information configured by the base station through at least one of RRC signaling, MAC CE and DCI. For example, the base station configures a set of frequency offsets through RRC signaling and further indicates which of these frequency offsets is to be used by the UE through MAC CE or DCI.

Second step: performing pre-compensation on uplink transmission including at least one of PUSCH, Physical Uplink Control Channel (PUCCH) and/or PRACH, based on the received UE specific frequency offset.

As can be seen from the above, the UE specific frequency offset may be a absolute amount that is used directly by the UE for pre-compensation; and/or, the UE specific frequency offset may be a relative amount of adjustment that is used by the UE for adjusting the frequency offset.

In an embodiment of the present application, in order to reduce the UE specific frequency offset updates to reduce signaling overhead, the method further includes: receiving drift rate of the UE specific pre-compensated frequency offset configured by the base station through RRC signaling; wherein the drift rate of the UE specific pre-compensated frequency offset is used to update the UE specific pre-compensated frequency offset. That is, the base station can configure the drift rate of the UE specific frequency offset through RRC signaling, in particular, the UE can update the frequency offset according to the following formulas:

$${DedicatedFO}_{new} = {DedicatedFO}_{old} + ( {T}_{new} - {T}_{old} ) * DriftRateOfDedicatedFO$$

wherein DedicatedFO_{new} is the updated UE specific frequency offset, DedicatedFO_{old} is the UE specific frequency offset used in the last uplink transmission, T_{new} is the time instance at which the frequency offset is updated, T_{old} is the time instance at which the last UE specific frequency offset was updated, and DriftRateOfDedicatedFO is the drift rate of the UE specific frequency offset configured by the base station through RRC signaling. This method can also be called open-loop uplink pre-compensated frequency offset control, as it does not require the base station to indicate the frequency offset amount of adjustment. The open-loop method can be used in conjunction with the closed-loop method described above.

In an embodiment of the present application, the method further includes: receiving validity period of the UE specific pre-compensated frequency offset configured by the base station through RRC signaling; wherein the validity period of the UE specific pre-compensated frequency offset is used to restrict lifetime of the UE specific pre-compensated frequency offset. That is, the base station can also configure validity period for the parameter DriftRateOfDedicatedFO. During the validity period of the DriftRateOfDedicatedFO, the UE can perform updates on the frequency offset based on the received DriftRateOfDedicatedFO; if the validity period is exceeded, the UE cannot perform updates on the frequency offset based on the DriftRateOfDedicatedFO, unless a new DriftRateOfDedicatedFO is received. The starting time of the validity period may start at the time instance at which the UE received the DriftRateOfDedicatedFO. For example, after receiving the DriftRateOfDedicatedFO, the UE starts a timer corresponding to its validity period.

In an embodiment of the present application, the validity period of the UE specific frequency offset is configured by the base station through RRC signaling, and is controlled by a timer. For example, the timer may be referred to as a frequency offset validity timer. The timer is started or restarted each time the UE receives frequency offset signaling transmitted by the base station, irrespective of whether the frequency offset is an absolute frequency offset or a relative frequency offset. Before the timer expires, the uplink pre-compensated frequency offset is considered to be valid, and the UE can transmit uplink transmission. After the timer expires, the uplink pre-compensated frequency offset is considered to be invalid, i.e., the uplink frequency is out of synchronization, and the UE cannot transmit uplink transmission and needs to re-obtain the uplink pre-compensated frequency offset. The UE can trigger the radio link failure (RLF) mechanism, i.e., clear all data in the hybrid automatic repeat request (HARQ) process buffer, and initiate a PRACH process to re-obtain the uplink pre-compensated frequency offset.

In an embodiment of the present application, the base station indicates the respective amount of adjustment of the pre-compensated frequency offset, and/or the amount of adjustment of the TA to a group of UEs through DCI, similar to the way in which the respective power control signaling is indicated to a group of UEs through DCI in existing systems. Wherein the DCI includes blocks which are in a one-to-one correspondence with at least one UE, and each of the blocks includes an indication field for an amount of adjustment of the UE specific pre-compensated frequency offset, and/or an indication field for an amount of adjustment of the TA.

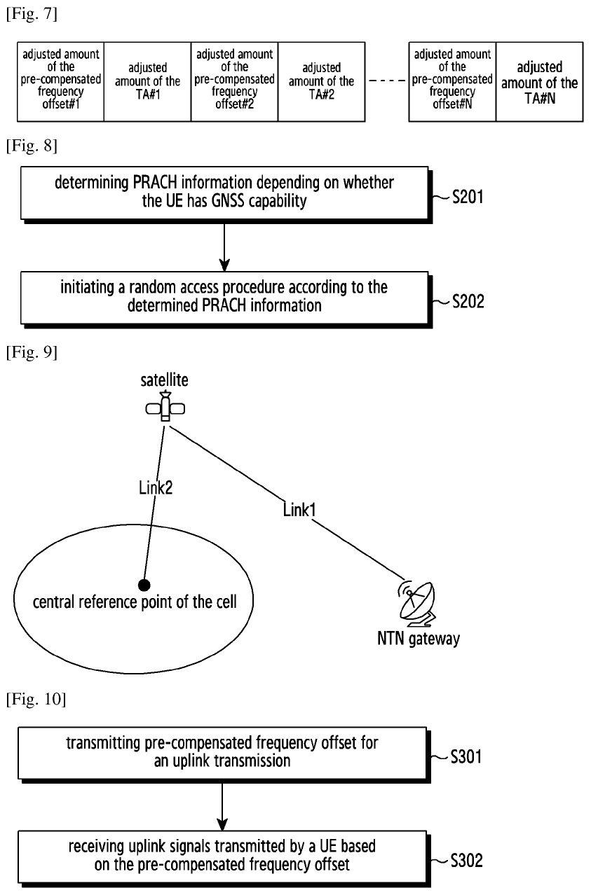

Specifically, as shown in FIG. 7, a DCI format includes a plurality of blocks, each of the blocks corresponds to one UE, and includes an indication field for an amount of adjustment of the pre-compensated frequency offset, and/or an indication field for an amount of adjustment of the TA.

In an embodiment of the present application, the method further includes: receiving location information about where the indication field for an amount of adjustment of the UE specific pre-compensated frequency offset, and/or the indication field for an amount of adjustment of the TA are located in the DCI, which is configured by the base station through RRC signaling, the location information is used for determining where the indication field for an amount of adjustment of the UE specific pre-compensated frequency offset, and/or the indication field for an amount of adjustment of the TA are located in the DCI.

Specifically, the base station configures the radio network temporary identity (RNTI) value scrambled with cyclic redundancy check (CRC) for the above DCI format for the UE through RRC signaling, and the UE monitors the DCI format according to the configured RNTI value. Also, the base station configures for the UE an index of its corresponding block in the DCI through RRC signaling, and after receiving the DCI format, the UE finds its own control signaling field based on the index of the block as configured as well as the number of bits contained in each block, and thus obtains the amount of adjustment of the pre-compensated frequency offset, and/or the amount of adjustment of the TA. Or, the base station configures for the UE the position information of its corresponding indication field in the DCI through RRC signaling, e.g., directly indicates at which bit the starting position of the indication field of the UE is located within the DCI. The base station can also configure the number of bits contained in the indication field of the UE through RRC signaling. The UE determines its own control signaling field in the DCI based on the position information and size of the DCI indication field as configured, and thus obtains the amount of adjustment of the pre-compensated frequency offset, and/or the amount of adjustment of the TA.

In an embodiment of the present application, the DCI for scheduling the PUSCH may additionally include an indication field for an amount of adjustment of the TA, and/or an indication field for the pre-compensated frequency offset. The UE may update the TA based on the amount of adjustment of the TA or update the pre-compensated frequency offset based on the amount of adjustment of the frequency offset, and use the updated TA and/or the frequency offset for the uplink transmission of this DCI scheduling.

In an embodiment of the present application, the UE is configured with a plurality of NTN uplink serving cells, and each of the serving cells corresponds to a different satellite. The system groups the plurality of serving cells. Cells belonging to the same group use the same uplink pre-compensated frequency offset, i.e., the base station maintains the same uplink pre-compensated frequency offset for a group of uplink serving cells of the UE. For example, the system groups the plurality of NTN serving cells into up to N groups, and configures each serving cell with a corresponding index, wherein the primary serving cell corresponds to the group with index of 0 by default.

In an embodiment of the present application, the UE is configured with two or more serving cells, wherein at least one serving cell is an NTN network, and at least one serving cell is a TN network; wherein the UE only performs frequency offset pre-compensation on uplink transmissions of NTN cells and does not need to perform frequency offset pre-compensation on uplink transmissions of TN cells.

All implementations with respect to the uplink pre-compensated frequency offset as described above may be changed simply to apply to uplink timing advance.

There is also provided a method performed by a UE according to an embodiment of the present application, as shown in FIG. 8, the method includes:

Step S201: determining PRACH related information depending on whether the UE has GNSS capability; and

Step S202: initiating a random access procedure according to the determined PRACH related information;
wherein the PRACH related information includes at least one of the following:
a restricted set for cyclic shift of the PRACH sequence;
configurations of the PRACH;
formats of the PRACH; and
resources of the PRACH.

In an embodiment of the present application, the restricted set for cyclic shift of the PRACH sequence is a set of PRACH configurations available for UEs without GNSS capability.

Specifically, in the NR system, the Zadoff-Chu (ZC) sequence is used as the preamble for the random access channel (RAC), and different preambles can be obtained via different cyclic shifts on the ZC sequence. The system supports two PRACH preamble formats with two different lengths. One is a long preamble format with sequence length of 839, it is used for frequency band below 6 GHZ, larger cell coverage scenarios, supports two subcarrier spacings of 1.25 kHz and 5 kHz, and supports three sets of cyclic shift, which are called non-restricted set, restricted set type A, and restricted set type B. Where the maximum frequency offset ranges supported by type A and B are of 1× subcarrier spacing and 2× subcarrier spacing, type A is used for normal moving scenarios, and type B is used for ultra-high-speed scenarios. The corresponding set of values for the cyclic shift is shown in Tables 1 and 2. The base station indicates which of the three sets of cyclic shift is used by the UE in the cell by means of the high-level signaling parameter restrictedSetConfig and indicates which of the 16 configurations is used by the UE in the cell by means of the high-level signaling parameter zeroCorrelationZoneConfig.

The other one is a short preamble format with sequence length of 139, it is used for frequency bands below and above 6 GHz, smaller cell coverage, and base station employing multi-beam scanning scenarios, and supports four subcarrier spacings of 15 kHz, 30 kHz, 60 kHz, and 120 kHz. Since the subcarrier spacing is less than 15 kHz, the restricted set of cyclic shift is not supported.

Table 1 shows Set of cyclic shift of the preamble sequence with corresponding subcarrier spacing of 1.25 kHz in NR system.

TABLE 1

| | N_{CS} value | | |
|---|---|---|---|
| | non- | restricted | restricted |
| N_{CS} | restricted | set type | set type |
| configuration | set | A | B |
| 0 | 0 | 15 | 15 |
| 1 | 13 | 18 | 18 |
| 2 | 15 | 22 | 22 |
| 3 | 18 | 26 | 26 |
| 4 | 22 | 32 | 32 |
| 5 | 26 | 38 | 38 |
| 6 | 32 | 46 | 46 |
| 7 | 38 | 55 | 55 |
| 8 | 46 | 68 | 68 |
| 9 | 59 | 82 | 82 |
| 10 | 76 | 100 | 100 |
| 11 | 93 | 128 | 118 |
| 12 | 119 | 158 | 137 |
| 13 | 167 | 202 | — |
| 14 | 279 | 237 | — |
| 15 | 419 | — | — |

Table 2 shows Set of cyclic shift of the preamble sequence with corresponding subcarrier spacing of 5 kHz in NR system.

TABLE 2

| | N_{CS} value | | |
|---|---|---|---|
| | non- | restricted | restricted |
| N_{CS} | restricted | set type | set type |
| configuration | set | A | B |
| 0 | 0 | 36 | 36 |
| 1 | 13 | 57 | 57 |
| 2 | 26 | 72 | 60 |
| 3 | 33 | 81 | 63 |
| 4 | 38 | 89 | 65 |
| 5 | 41 | 94 | 68 |
| 6 | 49 | 103 | 71 |
| 7 | 55 | 112 | 77 |
| 8 | 64 | 121 | 81 |
| 9 | 76 | 132 | 85 |
| 10 | 93 | 137 | 97 |
| 11 | 119 | 152 | 109 |
| 12 | 139 | 173 | 122 |
| 13 | 209 | 195 | 137 |
| 14 | 279 | 216 | — |
| 15 | 419 | 237 | — |

The choice of the cyclic shift amount has a large impact on performance of the random access. If the cyclic shift amount is too large, the number of preambles that may be generated by each ZC root sequence may be reduced, resulting in reduction of reuses of the ZC sequences, and increasing the inter-cell interference; if the cyclic shift amount is too small, the coverage of the small cell will be reduced, and requirements on networking cannot be satisfied. For low-speed cells, there is no restriction on the cyclic shift available, and the cyclic shift amount is chosen primarily on the basis of cell coverage; the larger the cell radius, the larger the cyclic shift amount that needs to be chosen. For high speed cells, in addition to considering factor of cell coverage, the effect of frequency offsets on the zero autocorrelation characteristics of the ZC sequence needs to be taken into account, i.e. certain cyclic shift cannot be used and the actual deployable cell radius is limited by the choice of cyclic shift.

When the UE is moving at high speed, due to the Doppler shift effect, there will be multiple correlation peaks on the base station side when doing PRACH correlation detection in the frequency domain, with the side peaks appearing at integer multiples of du from the main peak, wherein the value of du and the multiplicity of du at which the side peak position appears are related to the root sequence of PRACH preamble. When the frequency offset is large, the side peaks will exceed the main peaks, leading to serious false alarm problems, i.e., a preamble at one cyclic shift amount may be misjudged by the base station as a preamble at another cyclic shift amount. In other words, the frequency offset results in the base station not being able to distinguish between preambles of different cyclic shift under the same root sequence, which makes certain cyclic shift unusable. Therefore, in UE high-speed movement scenarios, the use of certain cyclic shift is restricted for different root sequence indexes to circumvent this problem. The restricted set of cyclic shift needs to be determined by traversing the simulations to screen out the cyclic shift under each root sequence that may be falsely alarmed due to frequency offsets.

For UEs without GNSS capability in NTN system, even if the base station configures the common frequency offset in the system information for the pre-compensation of PRACH, the residual frequency offset amount is still very large, thus the existing PRACH formats and configurations cannot be used, and the existing PRACH formats and/or configurations need to be enhanced. For example, adding new restricted set of the cyclic shift to the existing PRACH formats to support a larger range of frequency offset detection.

In an embodiment of the present application, the system defines a one new restricted set of the cyclic shift for UEs without GNSS capability to support a larger range of frequency offset detection. This restricted set of cyclic shift contains a smaller number of cyclic shift, and the UE without GNSS capability determines the cyclic shift amount based on this newly defined restricted set of the cyclic shift to generate the PRACH preamble. Alternatively, the system defines a plurality of new restrictive sets of the cyclic shift for UEs without GNSS capability to accommodate different ranges of frequency offset detection. The UE without GNSS capability determines an available set from this restricted set of multiple newly defined cyclic shift based on the parameter restrictedSetConfig configured by the base station, thus determining the cyclic shift amount to generate the PRACH preamble.

As above, the number of available cyclic shift for PRACH preamble may be significantly reduced to support a larger range of frequency offset detection. To ensure that a cell can have 64 preambles available, a cell needs to use more root sequences, the probability of neighbouring cells using the same root sequence increases and inter-cell interference will increase. Therefore, the number of available cyclic shift cannot be reduced excessively either, otherwise preamble misjudgments will occur when the frequency offset is large. For example, the base station determines that the preamble ID is A based on the position of the maximum correlation peak, in fact the UE may actually transmit a preamble ID that is also B, only that the transmitted signal experiences a large frequency offset. For this case, the base station can transmit RARs for all potentially confusing preamble IDs and identify the UE that transmitted the PRACH by decoding Msg3.

In an optional implementation, the base station transmits RARs for each of the two potentially confusing preamble IDs respectively. Wherein in RAR for preamble ID A, there is no need to indicate the uplink pre-compensated frequency offset, and this RAR can use the existing RAR format; and in RAR for preamble ID B, a larger frequency offset that cause preamble confusion needs to be indicated additionally for the frequency offset pre-compensation of uplink transmission at UE side, and this RAR can use the enhanced RAR format above. The base station may indicate the same or different Msg3 uplink scheduling resources in these two RARs, whether these two RARs indicate the same Msg3 uplink scheduling resources may depend on the implementations of the base station.

In an embodiment of the present application, the base station transmits the same RAR for the two potentially confusing preamble IDs, the RAPID field in MAC subheader of the RAR may indicate preamble ID A, and the preamble ID B and its corresponding uplink pre-compensated frequency offset are indicated additionally in the RAR. If the preamble ID transmitted by the UE is A, then no frequency offset pre-compensation is required for subsequent uplink transmissions; and, if the preamble ID transmitted by the UE is B, then pre-compensation for subsequent uplink transmissions is based on the frequency offset indicated in RAR. Alternatively, in addition to additionally indicating the preamble ID B and its corresponding larger frequency offset, there is an additional indication of a smaller frequency offset corresponding to the preamble ID A in RAR. If the preamble ID transmitted by the UE is A, then pre-compensation for subsequent uplink transmissions is based on the smaller frequency offset indicated in RAR; and, if the preamble ID transmitted by the UE is B, then pre-compensation for subsequent uplink transmissions is based on the larger frequency offset indicated in RAR. Msg3 is transmitted on the uplink scheduling resource indicated in RAR regardless of whether the UE transmits a preamble ID A or B.

Whether there is a possibility of confusion in the above preamble IDs depends on the decision of the base station. When it cannot be determined by the base station that a detected preamble ID has a higher probability of being correct, for example, when the preamble correlation detection result at the base station side shows two correlation peaks with a small difference in amplitude, the base station can use the above method to try to enable access of the UE that transmitted the PRACH to a network.

In an embodiment of the present application, there may be exist both UEs with GNSS capability and UEs without GNSS capability in an NTN cell, and these two types of UEs can be distinguished by the base station through PRACH configuration (PRACH related information). That is, two sets of PRACHs are configured respectively for both UEs with GNSS capability and UEs without GNSS capability, and a UE selects corresponding PRACH configuration for access to a network according to whether the UE itself has GNSS capability. Whether the two sets of PRACH configurations use the same PRACH format, the same set of cyclic shift, the same PRACH time domain resource, and/or the same PRACH preamble resource depend on configurations of the base station.

Since UEs with GNSS capability can estimate latency and frequency offset based on their own location information and that of the base station for pre-compensation of PRACH, the existing PRACH format can be used without being enhanced. Whereas UEs without GNSS capability cannot estimate latency and frequency offset for pre-compensation of PRACH, the existing PRACH format needs to be enhanced to support a larger range of latency and frequency offset detection. That is, UEs with GNSS capability and UEs without GNSS capability may use different PRACH formats for access to NTN networks.

In an optional implementation, UEs with GNSS capability and UEs without GNSS capability use different PRACH formats. For example, one PRACH format is defined by the system for UEs without GNSS capability, and the newly defined PRACH format may support a larger range of latency and frequency offset detection as compared with the existing PRACH formats.

In an optional implementation, UEs with GNSS capability and UEs without GNSS capability use different sets of cyclic shift of a preamble, different starting root sequence of a preamble, and/or different indexes of cyclic shift of a preamble. For example, different parameters of restrictedSetConfig, different parameters of prachRootSequenceIndex, and/or different parameters of zeroCorrelationZoneConfig are configured by the base station for UEs with GNSS capability and UEs without GNSS capability respectively.

In an optional implementation, UEs with GNSS capability and UEs without GNSS capability use different PRACH resources of the same PRACH configuration, including use of different PRACH time domain resources, use of different PRACH frequency domain resources, and/or use of different PRACH preambles.

In an optional implementation, UEs with GNSS capability and UEs without GNSS capability use different RAR formats. For example, UEs with GNSS capability can reuse RAR format of the existing system, whereas for UEs without GNSS capability, the RAR format of the existing system needs to be enhanced, e.g., the enhanced RAR format additionally includes an indication field for uplink pre-compensated frequency offset.

In an optional implementation, UEs with GNSS capability and UEs without GNSS capability use different indication ranges for TA control signaling, even if both use TA control signaling of the same number of bits, including TA control signaling in RAR, or TA control signaling carried by MAC CE.

In an optional implementation, UEs with GNSS capability and UEs without GNSS capability use different common TAs and/or common pre-compensated frequency offsets, i.e., the base station configure common TAs and/or common pre-compensated frequency offsets respectively for the two types of UEs through the system information. Here, the physical meaning of two types of UEs using different common TAs and/or common pre-compensated frequency offsets is that the common TAs and/or common pre-compensated frequency offsets correspond to different reference points. For example, as shown in FIG. 9, for UEs with GNSS capability, due to the ability to estimate the latency and frequency offset of the link between itself and the satellite, the common TA and common frequency offset it uses can correspond to the latency and frequency offset of the link (i.e., link 1 in FIG. 9) between the satellite and the gateway on the ground; for UEs without GNSS capability, due to lack of the ability to estimate the latency and frequency offset of the link between itself and the satellite, the common TA it uses corresponds to the sum of the latencies of the link (i.e., link 2 in FIG. 9) between central reference point of the cell and the satellite and the link (i.e., link 1 in FIG. 9) between the satellite and the gateway on the ground, and the common frequency offset it uses corresponds to the sum of the frequency offsets of link 1 in FIG. 9 and link 2 in FIG. 9.

The uplink transmission method according to an embodiment of the present application enables efficient uplink frequency synchronization.

There is also provided a method performed by a base station according to an embodiment of the present application, as shown in FIG. 10, the method includes:

Step S301: transmitting pre-compensated frequency offset for an uplink transmission; and

Step S302: receiving uplink signals transmitted by a UE based on the pre-compensated frequency offset.

Wherein the specific implementations can refer to the explanation above and will not be repeated here.

Optionally, the pre-compensated frequency offset includes at least one of the following:
common pre-compensated frequency offset;
UE specific pre-compensated frequency offset;
transmitting pre-compensated frequency offset for an uplink transmission includes at least one of the following:
transmitting the common pre-compensated frequency offset through the system information; and
transmitting the UE specific pre-compensated frequency offset through UE specific signaling.

Optionally, transmitting the UE specific pre-compensated frequency offset through UE specific signaling includes at least one of the following:
transmitting the UE specific pre-compensated frequency offset through the RAR;
transmitting the UE specific pre-compensated frequency offset through at least one of RRC signaling, MAC CE, and DCI.

Optionally, the UE specific pre-compensated frequency offset and the common pre-compensated frequency offset are in units of normalized reference subcarrier spacing; or
the value of the UE specific pre-compensated frequency offset or the common pre-compensated frequency offset is an integer or fractional multiples of the reference subcarrier spacing.

Optionally, the reference subcarrier spacing includes at least one of the following:
a subcarrier spacing of an initial uplink BWP configured by the base station through the system information;
a subcarrier spacing of an uplink activated BWP for the UE;
a subcarrier spacing configured by the base station; and
a predefined subcarrier spacing.

Optionally, transmitting the common pre-compensated frequency offset through the system information includes at least one of the following:
transmitting more than one common pre-compensated frequency offset by system information, the more than one common pre-compensated frequency offset corresponding to different SSB indexes respectively;
transmitting two common pre-compensated frequency offsets by the base station through the system information, the two common pre-compensated frequency offsets corresponding to UEs with GNSS capability and UEs without GNSS capability respectively.

Optionally, the UE specific pre-compensated frequency offset includes at least one of the following:
absolute amount for a UE specific pre-compensated frequency offset; and
relative adjustment amount for a UE specific pre-compensated frequency offset.

Optionally, the method further includes:
transmitting drift rate of the common pre-compensated frequency offset through the system information;
wherein the drift rate of the common pre-compensated frequency offset is used to update the common pre-compensated frequency offset.

Optionally, the method further includes:
transmitting a validity period of the common pre-compensated frequency offset through the system information;
wherein the validity period of the common pre-compensated frequency offset is used to restrict lifetime of the common pre-compensated frequency offset.

Optionally, the starting time of the validity period of the common pre-compensated frequency offset includes at least one of the following:
a time point indicated by the base station;
starting point or ending point of a system information modification period in which a system information transmission carries the common pre-compensated frequency offset;
starting point or ending point of a system information window in which the system information transmission carries the common pre-compensated frequency offset;
starting point or ending point of a slot, a subframe, and a radio frame in which a system information carrying the common pre-compensated frequency is firstly transmitted in a system information window;
starting point or ending point of a most recent radio frame with SFN=0 or hybrid-SFN=0 before the system information transmission carrying the common pre-compensated frequency offset;
starting point or ending point of a subframe, a slot, and a radio frame in which the system information transmission carrying the common pre-compensated frequency offset is received by the UE;
starting point or ending point of a subframe, a slot, and a radio frame in which a first repetition transmission for the system information transmission carrying the common pre-compensated frequency offset is received by the UE;
starting point or ending point of the system information transmission carrying the common pre-compensated frequency offset received by the UE; and
starting point or ending point of a first slot, subframe, or radio frame after the system information transmission carrying the common pre-compensated frequency offset is received by the UE.

Optionally, the method further includes:
transmitting drift rate of the UE specific pre-compensated frequency offset through RRC signaling;
wherein the drift rate of the UE specific pre-compensated frequency offset is used to update the UE specific pre-compensated frequency offset.

Optionally, the method further includes:
transmitting a validity period of the UE specific pre-compensated frequency offset through RRC signaling;
wherein the validity period of the UE specific pre-compensated frequency offset is used to restrict lifetime of the UE specific pre-compensated frequency offset.

Optionally, the RAR includes an indication field for indicating whether the UE specific pre-compensated frequency offset is included in the RAR.

Optionally, the DCI includes blocks which are in a one-to-one correspondence with at least one UE, and each of the blocks includes an indication field for an amount of adjustment of the UE specific pre-compensated frequency offset, and/or an indication field for an amount of adjustment of the TA.

Optionally, the method further includes:
transmitting, through RRC signaling, location information about where the indication field for an amount of adjustment of the UE specific pre-compensated frequency offset, and/or the indication field for an amount of adjustment of the TA are located in the DCI, the location information is used for determining where the indication field for an amount of adjustment of the UE specific pre-compensated frequency offset, and/or the indication field for an amount of adjustment of the TA are located in the DCI.

Methods according to various embodiments of the present application correspond to the methods according to various embodiments at UE side, and its detailed functional description and the achieved beneficial effects can specifically refer to the above description in corresponding method according to various embodiments at UE side and will not be repeated here.

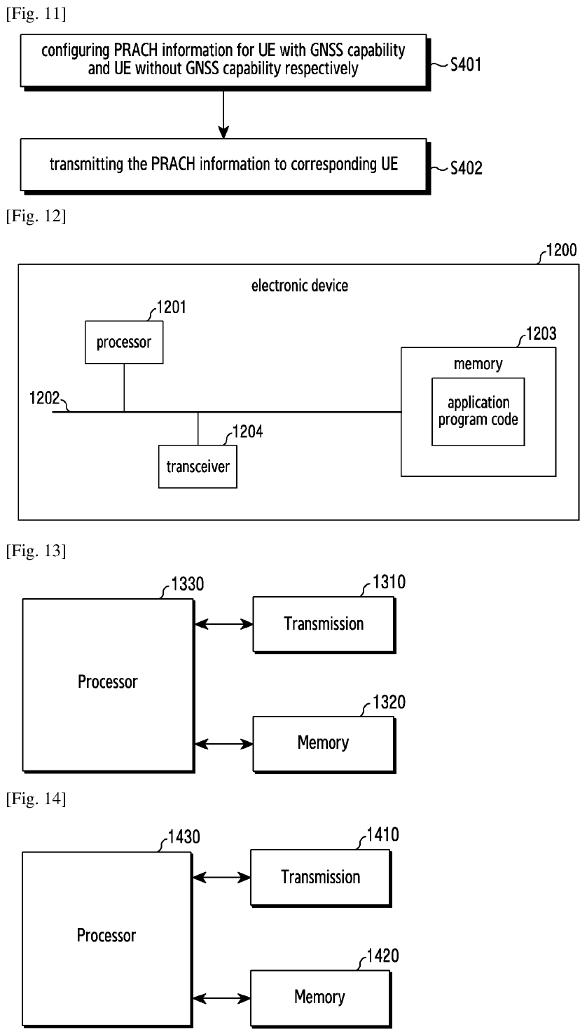

There is also provided a method performed by a base station according to an embodiment of the present application, as shown in FIG. 11, the method includes:

Step S401: configuring PRACH related information for UEs with GNSS capability and UEs without GNSS capability respectively;

Step S402: transmitting the PRACH related information to corresponding UEs;
the PRACH related information includes at least one of the following:
a restricted set for cyclic shift of the PRACH sequence;
configurations of the PRACH;
formats of the PRACH; and
resources of the PRACH.

Similarly, methods according to various embodiments of the present application correspond to the methods according to various embodiments at UE side, and its detailed functional description and the achieved beneficial effects can specifically refer to the above description in corresponding method according to various embodiments at UE side and will not be repeated here.

There is provided an electronic device according to an embodiment of the present application, in particular a user equipment, the user equipment 50 may include: a receiving module 501 and an execution module 502, wherein:
the receiving module 501 is used to receive the pre-compensated frequency offset configured by the base station; and
the execution module 502 is used to perform an uplink transmission based on the pre-compensated frequency offset.

Optionally, the pre-compensated frequency offset configured by the base station includes at least one of the following:
common pre-compensated frequency offset configured by the base station through system information; and
UE specific pre-compensated frequency offset configured by the base station through UE specific signaling.

Optionally, if the pre-compensated frequency offset includes the common pre-compensated frequency offset and the UE specific pre-compensated frequency offset, the execution module 502, when used to perform an uplink transmission based on the pre-compensated frequency offset, is specifically used to:
performing the uplink transmission based on a sum of the common pre-compensated frequency offset and the UE specific pre-compensated frequency offset.

Optionally, the UE specific pre-compensated frequency offset configured by the base station through the UE specific signaling includes at least one of the following:
UE specific pre-compensated frequency offset configured by the base station through the RAR; and
UE specific pre-compensated frequency offset configured by the base station through at least one of RRC signaling, MAC CE and DCI.

Optionally, the UE specific pre-compensated frequency offset and the common pre-compensated frequency offset are in units of normalized reference subcarrier spacing; or
the value of the UE specific pre-compensated frequency offset or the common pre-compensated frequency offset is an integer or fractional multiples of the reference subcarrier spacing.

Optionally, the reference subcarrier spacing includes at least one of the following:
a subcarrier spacing of an initial uplink BWP configured by the base station through the system information;
a subcarrier spacing of an uplink activated BWP for the UE;
a subcarrier spacing configured by the base station; and
a predefined subcarrier spacing.

Optionally, the common pre-compensated frequency offset configured by the base station through the system information includes at least one of the following:
more than one common pre-compensated frequency offset configured by the base station through the system information, the more than one common pre-compensated frequency offset corresponding to different SSB indexes respectively; and
two common pre-compensated frequency offsets configured by the base station through the system information, the two common pre-compensated frequency offsets corresponding to UEs with GNSS capability and UEs without GNSS capability respectively.

Optionally, the UE specific pre-compensated frequency offset includes at least one of the following:
absolute amount for a UE specific pre-compensated frequency offset; and
relative adjustment amount for a UE specific pre-compensated frequency offset.

Optionally, the receiving module 501 is further used to receive drift rate of the common pre-compensated frequency offset configured by the base station through the system information;
wherein the drift rate of the common pre-compensated frequency offset is used to update the common pre-compensated frequency offset.

Optionally, the user equipment 50 further includes:
determination module for determining a reference time point at which the common pre-compensated frequency offset comes into effect;
wherein the reference time point is used to update the common pre-compensated frequency offset.

Optionally, the receiving module 501 is further used to receive validity period of the common pre-compensated frequency offset configured by the base station through the system information;
wherein the validity period of the common pre-compensated frequency offset is used to restrict lifetime of the common pre-compensated frequency offset.

Optionally, the reference time point or starting time of the validity period of the common pre-compensated frequency offset includes at least one of the following:
a time point indicated by the base station;
starting point or ending point of a system information modification period in which a system information transmission carries the common pre-compensated frequency offset;
starting point or ending point of a system information window in which the system information transmission carries the common pre-compensated frequency offset;
starting point or ending point of a slot, a subframe, and a radio frame in which a system information carrying the common pre-compensated frequency is firstly transmitted in a system information window;
starting point or ending point of a most recent radio frame with SFN=0 or hybrid-SFN=0 before the system information transmission carrying the common pre-compensated frequency offset;
starting point or ending point of a subframe, a slot, and a radio frame in which the system information transmission carrying the common pre-compensated frequency offset is received by the UE;
starting point or ending point of a subframe, a slot, and a radio frame in which a first repetition transmission for the system information transmission carrying the common pre-compensated frequency offset is received by the UE;
starting point or ending point of the system information transmission carrying the common pre-compensated frequency offset received by the UE; and
starting point or ending point of a first slot, subframe, or radio frame after the system information transmission carrying the common pre-compensated frequency offset is received by the UE.

Optionally, the receiving module 501 is further used to receive drift rate of the UE specific pre-compensated frequency offset configured by the base station through RRC signaling;
wherein the drift rate of the UE specific pre-compensated frequency offset is used to update the UE specific pre-compensated frequency offset.

Optionally, the receiving module 501 is further used to receive validity period of the UE specific pre-compensated frequency offset configured by the base station through RRC signaling;
wherein the validity period of the UE specific pre-compensated frequency offset is used to restrict lifetime of the UE specific pre-compensated frequency offset.

Optionally, the RAR includes an indication field for indicating whether the UE specific pre-compensated frequency offset is included in the RAR.

Optionally, the DCI includes blocks which are in a one-to-one correspondence with at least one UE, and each of the blocks includes an indication field for an amount of adjustment of the UE specific pre-compensated frequency offset, and/or an indication field for an amount of adjustment of the TA.

Optionally, the receiving module 501 is further used to receive location information about where the indication field for an amount of adjustment of the UE specific pre-compensated frequency offset, and/or the indication field for an amount of adjustment of the TA are located in the DCI, which is configured by the base station through RRC signaling, the location information is used for determining where the indication field for an amount of adjustment of the UE specific pre-compensated frequency offset, and/or the indication field for an amount of adjustment of the TA are located in the DCI.

The electronic device according to embodiments of the present application can perform the methods according to embodiments of the present application, and the implementation principles thereof are similar. The actions to be performed by each module in the electronic device according to various embodiments of the present application correspond to the steps in methods according to various embodiments of the present application. The detailed functional description and the achieved beneficial effects for various modules of the electronic device can specifically refer to the above description in corresponding method and will not be repeated here.

There is provided an electronic device according to an embodiment of the present application, in particular a user equipment, the user equipment 60 may include: a determination module 601 and an initiating module 602, wherein:
the determination module 601 is used to determine PRACH related information based on whether the UE has GNSS capability;
the initiating module 602 is used to initiate a random access procedure according to the determined PRACH related information;
the PRACH related information includes at least one of the following:
a restricted set for cyclic shift of the PRACH sequence;
configurations of the PRACH;
formats of the PRACH; and
resources of the PRACH.

The electronic device according to embodiments of the present application can perform the methods according to embodiments of the present application, and the implementation principles thereof are similar. The actions to be performed by each module in the electronic device according to various embodiments of the present application correspond to the steps in methods according to various embodiments of the present application. The detailed functional description and the achieved beneficial effects for various modules of the electronic device can specifically refer to the above description in corresponding method and will not be repeated here.

There is provided an electronic device according to an embodiment of the present application, in particular a base station, the base station 70 may include: a transmitting module 701 and a receiving module 702, wherein:
the transmitting module 701 is used to transmit pre-compensated frequency offset for
an uplink transmission; and
the receiving module 702 is used to receive uplink signals transmitted based on the pre-compensated frequency offset.

Optionally, the pre-compensated frequency offset includes at least one of the following:
common pre-compensated frequency offset;
UE specific pre-compensated frequency offset;

When used to transmit the pre-compensated frequency offset for an uplink transmission, the transmitting module 701 is specifically used to perform at least one of the following:
transmitting the common pre-compensated frequency offset through the system information; and
transmitting the UE specific pre-compensated frequency offset through UE specific signaling.

Optionally, transmitting the UE specific pre-compensated frequency offset through UE specific signaling includes at least one of the following:
transmitting the UE specific pre-compensated frequency offset through the RAR;
transmitting the UE specific pre-compensated frequency offset through at least one of RRC signaling, MAC CE, and DCI.

Optionally, the UE specific pre-compensated frequency offset and the common pre-compensated frequency offset are in units of normalized reference subcarrier spacing; or
the value of the UE specific pre-compensated frequency offset or the common pre-compensated frequency offset is an integer or fractional multiples of the reference subcarrier spacing.

Optionally, the reference subcarrier spacing includes at least one of the following:
a subcarrier spacing of an initial uplink BWP configured by the base station through the system information;
a subcarrier spacing of an uplink activated BWP for the UE;
a subcarrier spacing configured by the base station; and
a predefined subcarrier spacing.

Optionally, when used to transmit the common pre-compensated frequency offset through the system information, the transmitting module 701 is used to perform at least one of the following:
transmitting more than one common pre-compensated frequency offset by system information, the more than one common pre-compensated frequency offset correspond to different SSB indexes respectively;
transmitting two common pre-compensated frequency offsets by the base station through the system information, the two common pre-compensated frequency offsets correspond to UEs with GNSS capability and UEs without GNSS capability respectively.

Optionally, the UE specific pre-compensated frequency offset includes at least one of the following:
absolute amount for a UE specific pre-compensated frequency offset; and
relative adjustment amount for a UE specific pre-compensated frequency offset.

Optionally, the transmitting module 701 is further used to transmit drift rate of the common pre-compensated frequency offset through the system information;
wherein the drift rate of the common pre-compensated frequency offset is used to update the common pre-compensated frequency offset.

Optionally, the transmitting module 701 is further used to transmit validity period of the common pre-compensated frequency offset through the system information;
wherein the validity period of the common pre-compensated frequency offset is used to restrict lifetime of the common pre-compensated frequency offset.

Optionally, the starting time of the validity period of the common pre-compensated frequency offset includes at least one of the following:
a time point indicated by the base station;
starting point or ending point of a system information modification period in which a system information transmission carries the common pre-compensated frequency offset;
starting point or ending point of a system information window in which the system information transmission carries the common pre-compensated frequency offset;
starting point or ending point of a slot, a subframe, and a radio frame in which a system information carrying the common pre-compensated frequency is firstly transmitted in a system information window;
starting point or ending point of a most recent radio frame with SFN=0 or hybrid-SFN=0 before the system information transmission carrying the common pre-compensated frequency offset;
starting point or ending point of a subframe, a slot, and a radio frame in which the system information transmission carrying the common pre-compensated frequency offset is received by the UE;
starting point or ending point of a subframe, a slot, and a radio frame in which a first repetition transmission for the system information transmission carrying the common pre-compensated frequency offset is received by the UE;
starting point or ending point of the system information transmission carrying the common pre-compensated frequency offset received by the UE; and
starting point or ending point of a first slot, subframe, or radio frame after the system information transmission carrying the common pre-compensated frequency offset is received by the UE.

Optionally, the transmitting module 701 is further used to transmit drift rate of the UE specific pre-compensated frequency offset through RRC signaling;
wherein the drift rate of the UE specific pre-compensated frequency offset is used to update the UE specific pre-compensated frequency offset.

Optionally, the transmitting module 701 is further used to transmit validity period of the UE specific pre-compensated frequency offset through RRC signaling;
wherein the validity period of the UE specific pre-compensated frequency offset is used to restrict lifetime of the UE specific pre-compensated frequency offset.

Optionally, the RAR includes an indication field for indicating whether the UE specific pre-compensated frequency offset is included in the RAR.

Optionally, the DCI includes blocks which are in a one-to-one correspondence with at least one UE, and each of the blocks includes an indication field for an amount of adjustment of the UE specific pre-compensated frequency offset, and/or an indication field for an amount of adjustment of the TA.

Optionally, the transmitting module 701 is further used to receive location information about where the indication field for an amount of adjustment of the UE specific pre-compensated frequency offset, and/or the indication field for an amount of adjustment of the TA are located in the DCI, which is transmitted through RRC signaling, the location information is used for determining where the indication field for an amount of adjustment of the UE specific pre-compensated frequency offset, and/or the indication field for an amount of adjustment of the TA are located in the DCI.

The electronic device according to embodiments of the present application can perform the methods according to embodiments of the present application, and the implementation principles thereof are similar. The actions to be performed by each module in the electronic device according to various embodiments of the present application correspond to the steps in methods according to various embodiments of the present application. The detailed functional description and the achieved beneficial effects for various modules of the electronic device can specifically refer to the above description in corresponding method and will not be repeated here.

There is provided an electronic device according to an embodiment of the present application, in particular a base station, the base station 80 may include: a configuration module 801 and a transmitting module 802, wherein:
the configuration module 801 is used to configure PRACH related information for UEs with GNSS capability and UEs without GNSS capability respectively;
the transmitting module 802 is used to transmit the PRACH related information to corresponding UEs;
the PRACH related information includes at least one of the following:
a restricted set for cyclic shift of the PRACH sequence;
configurations of the PRACH;
formats of the PRACH; and
resources of the PRACH.

The electronic device according to embodiments of the present application can perform the methods according to embodiments of the present application, and the implementation principles thereof are similar. The actions to be performed by each module in the electronic device according to various embodiments of the present application correspond to the steps in methods according to various embodiments of the present application. The detailed functional description and the achieved beneficial effects for various modules of the electronic device can specifically refer to the above description in corresponding method and will not be repeated here.

There is provided an electronic device according to an embodiment of the present application, which includes: a transceiver; and a processor coupled with the transceiver and configured to control to implement steps of the forgoing embodiments of various methods. Optionally, the electronic device may be a UE, a processor in the electronic device is configured to control to implement steps of methods performed by the UE that are provided in the forgoing embodiments of various methods. Optionally, the electronic device may be a base station, a processor in the electronic device is configured to control to implement steps of methods performed by the base station that are provided in the forgoing embodiments of various methods.

In an optional embodiment, there is provided an electronic device, as shown in FIG. 12. The electronic device 1200 as shown in FIG. 12 includes a processor 1201 and a memory 1203. Wherein the processor 1201 is connected with the memory 1203, for example, through the bus 1202. Optionally, the electronic device 1200 may further include a transceiver 1204, and the transceiver 1204 may be used for data interaction between the electronic device and other electronic devices, such as data transmission and/or data reception and so on. It is to be noted that, in practical applications, the number of the transceiver 1204 is not limited to 1, and the structure of the electronic device 1200 does not constitute any limitations to the embodiments of the present application.

The processor 1201 may be a central processing unit (CPU), a general-purpose processor, a digital signal processor (DSP), an application-specific integrated circuit (ASIC), a field programmable gate array (FPGA) or other programmable logic devices, transistor logic devices, hardware components, or any combination thereof. It may implement or execute the various exemplary logical blocks, modules and circuits described in connection with this disclosure. The processor 1201 may also be a combination for realizing computing functions, such as a combination including one or more microprocessors, a combination of a DSP and a microprocessor, and so on.

The bus 1202 may include a path to transfer information between the components described above. The bus 1202 may be a peripheral component interconnect (PCI) bus or an extended industry standard architecture (EISA) bus and so on. The bus 1202 may be divided into an address bus, a data bus, a control bus, and so on. For case of presentation, only one thick line is shown in FIG. 12, but it does not mean that there is only one bus or one type of bus.

The memory 1203 may be a read only memory (ROM) or other types of static storage devices that may store static information and instructions, a random access memory (RAM) or other types of dynamic storage devices that may store information and instructions, it may also be electrically erasable and programmable read only memory (EEPROM), compact disc read only memory (CD-ROM) or other optical disk storage, optical disk storage (including compressed compact disc, laser disc, compact disc, digital versatile disc, blu-ray disc, etc.), magnetic disk storage media, other magnetic storage devices, or any other medium capable of carrying or storing computer programs and capable of being read by a computer, without limitation therein.

The memory 1203 is used for storing a computer program for executing the embodiments of the present application, and the execution is controlled by the processor 1201. The processor 1201 is used to execute the computer program stored in the memory 1203 to implement the steps shown in the foregoing method embodiments.

FIG. 13 illustrates a structure of a UE according to an embodiment of the disclosure.

As shown in FIG. 13, the UE according to an embodiment may include a transceiver 1310, a memory 1320, and a processor 1330. The transceiver 1310, the memory 1320, and the processor 1330 of the UE may operate according to a communication method of the UE described above. However, the components of the UE are not limited thereto. For example, the UE may include more or fewer components than those described above. In addition, the processor 1330, the transceiver 1310, and the memory 1320 may be implemented as a single chip. Also, the processor 1330 may include at least one processor. Furthermore, the UE of FIG. 13 corresponds to the UE of the FIG. 1 and/or the UE of the FIG. 4.

The transceiver 1310 collectively refers to a UE receiver and a UE transmitter, and may transmit/receive a signal to/from a base station or a network entity. The signal transmitted or received to or from the base station or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the UE. Also, the memory 1320 may store control information or data included in a signal obtained by the UE. The memory 1320 may be a storage medium, such as read-only memory (ROM), random access memory (RAM), a hard disk, a CD-ROM, and a DVD, or a combination of storage media.

The processor 1330 may control a series of processes such that the UE operates as described above. For example, the transceiver 1310 may receive a data signal including a control signal transmitted by the base station or the network entity, and the processor 1330 may determine a result of receiving the control signal and the data signal transmitted by the base station or the network entity.

FIG. 14 illustrates a structure of a base station according to an embodiment of the disclosure.

As shown in FIG. 14, the base station according to an embodiment may include a transceiver 1410, a memory 1420, and a processor 1430. The transceiver 1410, the memory 1420, and the processor 1430 of the base station may operate according to a communication method of the base station described above. However, the components of the base station are not limited thereto. For example, the base station may include more or fewer components than those described above. In addition, the processor 1430, the transceiver 1410, and the memory 1420 may be implemented as a single chip. Also, the processor 1430 may include at least one processor. Furthermore, the base station of FIG. 14 corresponds to the BS of the FIG. 1 and the base station of the FIG. 4.

The transceiver 1410 collectively refers to a base station receiver and a base station transmitter, and may transmit/receive a signal to/from a terminal (UE) or a network entity. The signal transmitted or received to or from the terminal or a network entity may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the base station. Also, the memory 1420 may store control information or data included in a signal obtained by the base station. The memory 1420 may be a storage medium, such as read-only memory (ROM), random access memory (RAM), a hard disk, a CD-ROM, and a DVD, or a combination of storage media.

The processor 1430 may control a series of processes such that the base station operates as described above. For example, the transceiver 1410 may receive a data signal including a control signal transmitted by the terminal, and the processor 1430 may determine a result of receiving the control signal and the data signal transmitted by the terminal.

Embodiments of the present application provide a computer-readable storage medium having a computer program stored thereon, and the computer program, when executed by a processor, may implement the steps and corresponding contents of foregoing method embodiments.

Embodiments of the present application further provide a computer program product including a computer program, and the computer program, when executed by a processor, may implement the steps and corresponding contents of foregoing method embodiments.

It should be understood that, although each operation step are indicated by arrows in the flowcharts of the embodiments of the present application, the implementation order of these steps is not limited to the order indicated by the arrows. Unless explicitly stated herein, in some implementation scenarios of the embodiments of the present application, the implementation steps in each flowchart may be performed in other orders as required. Further, part or all of the steps in each flowchart are based on actual implementation scenarios, and may include a plurality of sub-steps or a plurality of stages. Part or all of these sub-steps or stages may be executed at the same moments, and each sub-step or stage of these sub-steps or stages may also be executed at different moments, respectively. In scenarios with different execution moments, the execution order of these sub-steps or stages may be flexibly configured according to requirements, which is not limited in this embodiment of the present application.

The above are only optional implementations of some implementing scenarios in this application.

It should be pointed out that, for a person of ordinary skill in the art, without departing from the technical idea of the solutions of the present application, other similar implementation means based on the technical idea of the present application shall also fall into the protection scope of the embodiments of the present application.

An aspect of the disclosure provides a method performed by a User Equipment (UE), and the method comprises receiving pre-compensated frequency offset configured by a base station and performing an uplink transmission based on the pre-compensated frequency offset.

The pre-compensated frequency offset configured by the base station may include at least one of common pre-compensated frequency offset configured by the base station through system information or UE specific pre-compensated frequency offset configured by the base station through UE specific signaling.

In case that the pre-compensated frequency offset includes the common pre-compensated frequency offset and the UE specific pre-compensated frequency offset, performing an uplink transmission based on the pre-compensated frequency offset may include performing the uplink transmission based on a sum of the common pre-compensated frequency offset and the UE specific pre-compensated frequency offset.

The UE specific pre-compensated frequency offset configured by the base station through the UE specific signaling may include at least one of the UE specific pre-compensated frequency offset configured by the base station through a random access response (RAR) or the UE specific pre-compensated frequency offset configured by the base station through at least one of RRC signaling, medium access control′ control element (MAC CE) and downlink control information (DCI).

The UE specific pre-compensated frequency offset and the common pre-compensated frequency offset may be in units of normalized reference subcarrier spacing or the value of the UE specific pre-compensated frequency offset or the common pre-compensated frequency offset may be an integer or fractional multiples of the reference subcarrier spacing.

The reference subcarrier spacing may include at least one of a subcarrier spacing of an initial uplink Bandwidth Part (BWP) configured by the base station through the system information, a subcarrier spacing of an uplink activated BWP for the UE, a subcarrier spacing configured by the base station and a predefined subcarrier spacing.

The common pre-compensated frequency offset configured by the base station through the system information may include at least one of more than one common pre-compensated frequency offset configured by the base station through the system information, or two common pre-compensated frequency offsets configured by the base station through the system information. The more than one common pre-compensated frequency offset may correspond to different Synchronization Signal Block (SSB) indexes respectively the two common pre-compensated frequency offsets may correspond to UEs with GNSS capability and UEs without GNSS capability respectively.

The UE specific pre-compensated frequency offset may include at least one of absolute amount for a UE specific pre-compensated frequency offset or relative adjustment amount for a UE specific pre-compensated frequency offset.

The method may comprise receiving a drift rate of the common pre-compensated frequency offset configured by the base station through the system information. The drift rate of the common pre-compensated frequency offset is used to update the common pre-compensated frequency offset.

The method may comprise determining a reference time point at which the common pre-compensated frequency offset comes into effect. The reference time point is used to update the common pre-compensated frequency offset.

The method may further comprise receiving a validity period of the common pre-compensated frequency offset configured by the base station through the system information. The validity period of the common pre-compensated frequency offset is used to restrict lifetime of the common pre-compensated frequency offset.

The reference time point and the starting time of the validity period of the common pre-compensated frequency offset may include at least one of a time point indicated by the base station, starting point or ending point of a system information modification period in which a system information transmission carries the common pre-compensated frequency offset, starting point or ending point of a system information window (SI Window) in which the system information transmission carries the common pre-compensated frequency offset, starting point or ending point of a slot, a subframe, and a radio frame in which a system information carrying the common pre-compensated frequency is firstly transmitted in a system information window, starting point or ending point of a most recent radio frame with SFN=0 or hybrid-SFN=0 before the system information transmission carrying the common pre-compensated frequency offset, starting point or ending point of a subframe, a slot, and a radio frame in which the system information transmission carrying the common pre-compensated frequency offset is received by the UE, starting point or ending point of a subframe, a slot, and a radio frame in which a first repetition transmission for the system information transmission carrying the common pre-compensated frequency offset is received by the UE, starting point or ending point of the system information transmission carrying the common pre-compensated frequency offset received by the UE and starting point or ending point of a first slot, subframe, or radio frame after the system information transmission carrying the common pre-compensated frequency offset is received by the UE.

The method may further comprise receiving a drift rate of the UE specific pre-compensated frequency offset configured by the base station through RRC signaling. The drift rate of the UE specific pre-compensated frequency offset is used to update the UE specific pre-compensated frequency offset.

The method may further comprise receiving a validity period of the UE specific pre-compensated frequency offset configured by the base station through RRC signaling. The validity period of the UE specific pre-compensated frequency offset is used to restrict lifetime of the UE specific pre-compensated frequency offset.

The RAR may include an indication field for indicating whether the UE specific pre-compensated frequency offset is included in the RAR.

The DCI may include blocks which are in a one-to-one correspondence with at least one UE, and each of the blocks may include an indication field for an amount of adjustment of the UE specific pre-compensated frequency offset, and/or an indication field for an amount of adjustment of timing advance (TA).

The method may further comprise receiving location information about where the indication field for an amount of adjustment of the UE specific pre-compensated frequency offset, and/or the indication field for an amount of adjustment of the TA are located in the DCI, which is configured by the base station through RRC signaling, and the location information is used for determining where the indication field for an amount of adjustment of the UE specific pre-compensated frequency offset, and/or the indication field for an amount of adjustment of the TA are located in the DCI.

An aspect of the disclosure provides a method performed by a UE is also provided, and the method may comprise determining physical random access channel (PRACH) related information according to whether the UE has GNSS capability, initiating a random access procedure according to the determined PRACH related information, and the PRACH related information includes at least one of a restricted set for cyclic shift of the PRACH sequence, configurations of the PRACH, formats of the PRACH and resources of the PRACH.

An aspect of the disclosure provides a method performed by a base station is also provided, and the method comprises transmitting pre-compensated frequency offset for an uplink transmission and receiving uplink signals transmitted based on the pre-compensated frequency offset.

The pre-compensated frequency offset may include at least one of common pre-compensated frequency offset or UE specific pre-compensated frequency offset, transmitting pre-compensated frequency offset for an uplink transmission may include at least one of transmitting the common pre-compensated frequency offset through the system information or transmitting the UE specific pre-compensated frequency offset through UE specific signaling.

The UE specific pre-compensated frequency offset transmitted through the UE specific signaling may include at least one of transmitting the UE specific pre-compensated frequency offset through the RAR, or transmitting the UE specific pre-compensated frequency offset through at least one of RRC signaling, MAC CE, and DCI.

The UE specific pre-compensated frequency offset and the common pre-compensated frequency offset may be in units of normalized reference subcarrier spacing or the value of the UE specific pre-compensated frequency offset or the common pre-compensated frequency offset may be an integer or fractional multiples of the reference subcarrier spacing.

The reference subcarrier spacing includes at least one of a subcarrier spacing of an initial uplink BWP configured by the base station through the system information, a subcarrier spacing of an uplink activated BWP for the UE, a subcarrier spacing configured by the base station or a predefined subcarrier spacing.

Transmitting the common pre-compensated frequency offset through the system information may include at least one of transmitting more than one common pre-compensated frequency offset by system information, or transmitting two common pre-compensated frequency offsets by the base station through the system information. The more than one common pre-compensated frequency offset may correspond to different SSB indexes respectively and the two common pre-compensated frequency offsets may correspond to UEs with GNSS capability and UEs without GNSS capability respectively.

The UE specific pre-compensated frequency offset includes at least one of absolute amount for a UE specific pre-compensated frequency offset or relative adjustment amount for a UE specific pre-compensated frequency offset.

The method may further comprise transmitting a drift rate of the common pre-compensated frequency offset through the system information. The drift rate of the common pre-compensated frequency offset is used to update the common pre-compensated frequency offset.

The method may further comprise transmitting a validity period of the common pre-compensated frequency offset through the system information, and the validity period of the common pre-compensated frequency offset is used to restrict lifetime of the common pre-compensated frequency offset.

Starting time of the validity period of the common pre-compensated frequency offset may includes at least one of a time point indicated by the base station, starting point or ending point of a system information modification period in which a system information transmission carries the common pre-compensated frequency offset, starting point or ending point of a system information window in which the system information transmission carries the common pre-compensated frequency offset, starting point or ending point of a slot, a subframe, and a radio frame in which a system information carrying the common pre-compensated frequency is firstly transmitted in a system information window, starting point or ending point of a most recent radio frame with SFN=0 or hybrid-SFN=0 before the system information transmission carrying the common pre-compensated frequency offset, starting point or ending point of a subframe, a slot, and a radio frame in which the system information transmission carrying the common pre-compensated frequency offset is received by the UE, starting point or ending point of a subframe, a slot, and a radio frame in which a first repetition transmission for the system information transmission carrying the common pre-compensated frequency offset is received by the UE, starting point or ending point of the system information transmission carrying the common pre-compensated frequency offset received by the UE or starting point or ending point of a first slot, subframe, or radio frame after the system information transmission carrying the common pre-compensated frequency offset is received by the UE.

The method may further comprise transmitting a drift rate of the UE specific pre-compensated frequency offset through RRC signaling, and the drift rate of the UE specific pre-compensated frequency offset is used to update the UE specific pre-compensated frequency offset.

The method may further comprise transmitting a validity period of the UE specific pre-compensated frequency offset through RRC signaling, and the validity period of the UE specific pre-compensated frequency offset is used to restrict lifetime of the UE specific pre-compensated frequency offset.

The RAR may include an indication field for indicating whether the UE specific pre-compensated frequency offset is included in the RAR.

The DCI may include blocks which are in a one-to-one correspondence with at least one UE, and each of the blocks may include an indication field for an amount of adjustment of the UE specific pre-compensated frequency offset, and/or an indication field for an amount of adjustment of the TA.

The method may further comprise transmitting, through RRC signaling, location information about where the indication field for an amount of adjustment of the UE specific pre-compensated frequency offset, and/or the indication field for an amount of adjustment of the TA are located in the DCI, and the location information is used for determining where the indication field for an amount of adjustment of the UE specific pre-compensated frequency offset, and/or the indication field for an amount of adjustment of the TA are located in the DCI.

An aspect of the disclosure provides a method performed by a base station, and the method may comprise configuring PRACH related information for UEs with GNSS capability and UEs without GNSS capability respectively, and transmitting the PRACH related information to corresponding UEs, and the PRACH related information includes at least one of the following a restricted set for cyclic shift of the PRACH sequence, configurations of the PRACH, formats of the PRACH and resources of the PRACH.

An aspect of the disclosure provides an electronic device is provided, the electronic device may comprise a transceiver and a processor coupled with the transceiver and configured to control to perform steps of the method performed by a UE according to the present application.

An aspect of the disclosure provides an electronic device, and the electronic device may comprise a transceiver and a processor coupled with the transceiver and configured to control to perform steps of the method performed by a base station according to the present application.

An aspect of the disclosure provides a computer-readable storage medium having a computer program stored thereon, and the computer program, when executed by a processor, implements the steps of the method according to the present application.

An aspect of the disclosure provides a computer program product including a computer program, and the computer program, when executed by a processor, implements the steps of the method according to the present application.

With the uplink transmission method, the electronic device and the computer readable storage medium, pre-compensated frequency offset configured by the base station is received, and then uplink transmission is performed based on the pre-compensated frequency offset. Thus uplink frequency synchronization can be achieved effectively without the assistance of GNSS.

The method performed by a base station may comprise configuring a pre-compensated frequency offset, and transmitting the pre-compensated frequency offset to a user equipment (UE), and an uplink transmission is performed based on the pre-compensated frequency offset.

The pre-compensated frequency offset configured by the base station comprises at least one of common pre-compensated frequency offset configured by the base station through system information, or UE specific pre-compensated frequency offset configured by the base station through UE specific signaling.

The method may comprise transmitting a validity period of the common pre-compensated frequency offset configured by the base station through the system information, the validity period of the common pre-compensated frequency offset is used to restrict lifetime of the common pre-compensated frequency offset

The method may comprise transmitting a drift rate of the UE specific pre-compensated frequency offset configured by the base station through RRC signaling, and the drift rate of the UE specific pre-compensated frequency offset is used to update the UE specific pre-compensated frequency offset.

In case that the pre-compensated frequency offset includes the common pre-compensated frequency offset and the UE specific pre-compensated frequency offset, the uplink transmission is performed based on a sum of the common pre-compensated frequency offset and the UE specific pre-compensated frequency offset.

1. A method performed by a user equipment (UE) comprising:
receiving pre-compensated frequency offset configured by a base station; and
performing an uplink transmission based on the pre-compensated frequency offset.

2. The method of claim 1, wherein the pre-compensated frequency offset configured by the base station comprises at least one of common pre-compensated frequency offset configured by the base station through system information, or UE specific pre-compensated frequency offset configured by the base station through UE specific signaling.

3. The method of claim 2, wherein in case that the pre-compensated frequency offset includes the common pre-compensated frequency offset and the UE specific pre-compensated frequency offset, performing the uplink transmission based on the pre-compensated frequency offset comprises:
performing the uplink transmission based on a sum of the common pre-compensated frequency offset and the UE specific pre-compensated frequency offset.

4. The method of claim 2, wherein the UE specific pre-compensated frequency offset configured by the base station through the UE specific signaling comprises at least one of the UE specific pre-compensated frequency offset configured by the base station through a random access response (RAR), or the UE specific pre-compensated frequency offset configured by the base station through at least one of RRC signaling, medium access control control element (MAC CE) and downlink control information (DCI).

5. The method of claim 4, wherein the RAR includes an indication field for indicating whether the UE specific pre-compensated frequency offset is included in the RAR.

6. The method of claim 4, wherein the DCI includes blocks which are in a one-to-one correspondence with at least one UE, and each of the blocks includes an indication field for an amount of adjustment of the UE specific pre-compensated frequency offset, and/or an indication field for an amount of adjustment of timing advance (TA).

7. The method of claim 2, wherein the UE specific pre-compensated frequency offset and the common pre-compensated frequency offset are in units of normalized reference subcarrier spacing, or
wherein the value of the UE specific pre-compensated frequency offset or the common pre-compensated frequency offset is an integer or fractional multiples of the reference subcarrier spacing.

8. The method of claim 2, wherein the common pre-compensated frequency offset configured by the base station through the system information comprises at least one of more than one common pre-compensated frequency offset configured by the base station through the system information, or two common pre-compensated frequency offset configured by the base station through the system information, wherein the more than one common pre-compensated frequency offset corresponds to different synchronization signal block (SSB) indexes respectively, and
wherein the two common pre-compensated frequency offset correspond to UEs with GNSS capability and UEs without GNSS capability respectively.

9. The method of claim 2, wherein the UE specific pre-compensated frequency offset comprises at least one of absolute amount for a UE specific pre-compensated frequency offset or relative adjustment amount for a UE specific pre-compensated frequency offset.

10. The method of claim 2, further comprising:
receiving a drift rate of the common pre-compensated frequency offset configured by the base station through the system information;
wherein the drift rate of the common pre-compensated frequency offset is used to update the common pre-compensated frequency offset.

11. A method performed by a base station, the method comprising:
configuring a pre-compensated frequency offset, and
transmitting the pre-compensated frequency offset to a user equipment (UE),
wherein an uplink transmission is performed based on the pre-compensated frequency offset.

12. The method of claim 11, wherein the pre-compensated frequency offset configured by the base station comprises at least one of common pre-compensated frequency offset configured by the base station through system information, or UE specific pre-compensated frequency offset configured by the base station through UE specific signaling.

13. The method of claim 12, further comprising:
transmitting a validity period of the common pre-compensated frequency offset configured by the base station through the system information,
wherein the validity period of the common pre-compensated frequency offset is used to restrict lifetime of the common pre-compensated frequency offset.

14. The method of claim 12, further comprising:
transmitting a drift rate of the UE specific pre-compensated frequency offset configured by the base station through RRC signaling;
wherein the drift rate of the UE specific pre-compensated frequency offset is used to update the UE specific pre-compensated frequency offset.

15. The method of claim 12, wherein in case that the pre-compensated frequency offset includes the common pre-compensated frequency offset and the UE specific pre-compensated frequency offset, the uplink transmission is performed based on a sum of the common pre-compensated frequency offset and the UE specific pre-compensated frequency offset.
